(19) United States
(12) Patent Application Publication
(10) Pub. No.: US 2018/0070060 A1
(43) Pub. Date: Mar. 8, 2018

(54) IN-CAR DIGITAL VIDEO SYSTEM WITH INTEGRATED ALPR

(71) Applicant: KUSTOM SIGNALS, INC., Lenexa, KS (US)

(72) Inventors: Warren Page, Lenexa, KS (US); Michael Paulson, Lawrence, KS (US); Dave Teeter, Lenexa, KS (US)

(21) Appl. No.: 15/540,328

(22) PCT Filed: Dec. 1, 2015
(86) PCT No.: PCT/US15/63270

§ 371 Date: Jun. 28, 2017

(51) Int. Cl. H04N 7/18; B60R 11/04; G06K 9/00

(52) U.S. Cl. CPC H04N 7/188; B60R 11/04; G06K 2209/15; G06K 9/00791; G06K 9/00771

(57) ABSTRACT

A video surveillance system for law enforcement and related applications with an integrated in-car video system and automatic license plate recognition system. A hit from the ALPR system triggers the ICV system to begin recording and to associate the recorded AV data with the ALPR data.

### CROSS-REFERENCE TO RELATED APPLICATION

This application claims the benefit of co-pending provisional application Ser. No. 62/085,998, filed on Dec. 1, 2014, entitled IN-CAR DIGITAL VIDEO SYSTEM WITH INTEGRATED ALPR.

### FIELD

The present invention relates to video surveillance systems, and more particularly, to an in-car video system with integrated automatic license plate recognition for law enforcement and related applications.

### BACKGROUND

In law enforcement, a reliable witness that is incapable of perjury is needed to substantiate the actions taken by the law enforcement officer and to protect the officer against false allegations by the persons involved in the incident. An excellent witness of this type is a video recording of the incident, now widely used in traffic stops and criminal interdictions, which can be reviewed after the incident and archived. By recording the incident first-hand as it actually happened, video recordings eliminate conflicting individual interpretations of the incident and facilitate effective and efficient law enforcement.

ALPR video cameras/capture systems are increasingly used by police, public safety officials, and others to capture license plate information, and identify or locate specific vehicles from comparing the captured license plate information with previously identified license plate numbers on a “hit list” or “hot list” of license plates. However, there has not been an effective method for the captured/identified ALPR video, photographs and/or data to be associated with the ICV video of the same event. Additionally, retrieving the In-Car video and associating it with the ALPR video, photographs and/or data of the same incident has been problematic for back-office applications. Typically, ALPR and ICV systems employ separate video records and separate back-office applications that do not (and cannot) cross reference records between one another.

### SUMMARY

The digital video surveillance system of the present invention includes an In-Car Digital Video system (ICV) which allows recording to various digital media including SD cards, SSDs, Compact Flash disks, mSATA devices or the like. This system includes a memory buffer that is recording at all times (look-back buffer, or pre-event video). When the recorder is activated, the memory buffer contents, including video and audio, will be recorded onto the media before the system starts recording directly from the video camera. This pre-event video ensures that the activity occurring just prior to the activation of the system is recorded as well. The system includes the space and connections necessary for incorporating an ALPR system within the enclosure of the ICV's digital video recorder (DVR).

The ALPR system may be associated with the ICV system (or vice-versa) by direct physical inclusion of the ALPR capture circuitry into the DVR. The ICV system may detect and recognize the presence and ready status of the ALPR system, control its power, and be able to enable or disable the ALPR functions. Power, signals, and connections may be provided to the ALPR system by the ICV system. The ALPR cameras are connected directly to the ALPR sub-system. Ethernet or other pathways for communication are provided and managed by the ICV system as well. Protocols are in place to allow constant communication between the ICV and ALPR systems for the exchange of information and commands.

### BRIEF DESCRIPTION OF THE DRAWINGS

FIG. 1 is a functional block diagram showing the basic components of the integrated video surveillance system, and the components of interaction between the ALPR system and the in-car video system;

FIG. 2 is a software flow diagram showing interaction and exchange of information between the ALPR and ICV systems; and

FIG. 3 is an example of a communication protocol between the ALPR system and the ICV system.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

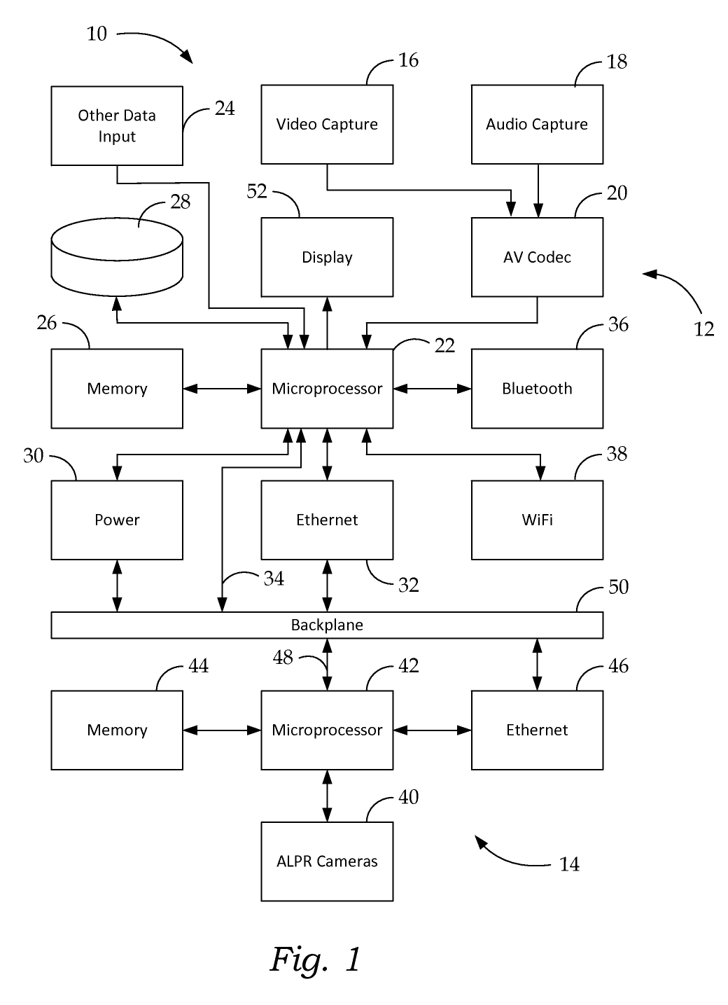

Referring to FIG. 1, a digital video surveillance system of the present invention is generally indicated by reference numeral 10. The digital video surveillance system of the present invention includes an In-Car Digital Video system (ICV) 12 integrated with an Automated License Plate Reader system (ALPR) 14. The ICV system 12 may be mounted in a law enforcement vehicle to record audio and video from the vehicle.

The ICV system 12 includes a video capture board 16 coupled to one or more video cameras (not shown) and an audio capture board 18 coupled to one or more microphones, each of which are coupled to an audio/video codec 20, which encodes and decodes the video stream from the video capture board 16 and audio data stream from the audio capture system 18 under control of a microprocessor 22. The microprocessor 22 receives audio and video data, along with other data from sources such as radar units, GPS, and clock 24, for example and transfers the data to a temporary memory buffer 26. The ICV system 12 may be configured to store recorded data on a mass storage device 28, based on events (i.e., triggers) such as activation of the emergency lights/siren, acceleration, GPS inputs, crash detection, wireless mic activation, ALPR trigger, and manual activation, for example. The ICV system 12 records to various digital media 28 including SD cards, SSDs, Compact Flash disks, mSATA devices or the like. The ICV system may include a memory 26 buffer that is recording at all times (look-back buffer, or pre-event video). When the recorder 12 is activated, the memory 26 buffer contents, including video and audio, may be transferred to the digital media 28 before the system starts recording directly from the audio and video sources. This pre-event video ensures that the activity occurring just prior to the activation of the system is recorded as well.

The ICV system 12 includes a power supply 30, Ethernet communications ports 32, and one or more general purpose input/output channels (GPIO) 34. The ICV system 12 may also include a WiFi interface 36 and Bluetooth 38 interface for wireless communications to base units, body-worn video systems, or wireless microphones, for example.

In the preferred embodiment, the ALPR system 14 is associated with the ICV system by direct physical inclusion of the ALPR capture circuitry into the ICV system 12. The ALPR system 14 includes one or more ALPR cameras 40 coupled to a microprocessor 42. Data from the ALPR cameras are stored in a memory 44. ALPR license plate data may also be stored in the memory 44. The ALPR system 14 communicates through one or more Ethernet communication ports 46 and one or more GPIO channels 48. Communication between the ICV system 12 and the ALPR system 14 may be accomplished through a backplane 50, which provides hardware connectors, and power.

The ICV system 12 detects and recognizes the presence and ready status of the ALPR system 14, controls its power, and the enabling or disabling of the ALPR functions. Power, signals, and connections are provided to the ALPR system 14 by the ICV system 12 through the backplane 50. The ALPR cameras 40 are connected directly to the ALPR sub-system 14. Ethernet 46 or other pathways for communication 48 are provided and managed by the ICV system 12 as well. The ICV 12 and ALPR 14 systems are in constant communication for the exchange of information and commands.

ALPR systems have different categories, or thresholds of “hits,” or matches between a license plate that is read by the system, and the database license information, dependent upon the type of infraction that is associated with that particular license plate. For example, there may be one category for a license plate associated with a non-registration of that vehicle, and another category associated with a stolen vehicle. These categories or thresholds are typically prioritized in increasing levels of infraction severity. The ALPR system 14 will notify the ICV system 12 if a license plate “hit” of a certain threshold level has been met or exceeded. This will allow the ICV system 12 to be triggered to perform a desired function, such as recording an Audio-Video (AV) file or record of the incident that triggered the hit and/or displaying snapshots or hit information on an ICV display 52. With the ICV system's lookback buffering, the vehicle that triggered the hit may be captured on the ICV system's recorded AV file in the form of specific metadata, prior to the hit being processed by the ALPR system 14. If the officer elects to stop the suspect vehicle, all of that video will be captured and can be associated with the ALPR hit. This allows collaborative data to be shared between the ALPR system 14 and the ICV system 12, enabling shared searches for video and ALPR records, etc. from the back office function, once the ALPR data and ICV video has been stored.

ALPR systems 14 typically utilize Optical Character Recognition (OCR) to determine the text on a license plate. In the acquisition of this information, a snapshot of the vehicle's license plate is taken, or “plate patch,” along with a color overview photograph to ascertain the make and model of the vehicle associated with that license plate. With an ALPR system 14 integrated into the ICV system 12, these snapshots can be identified and stored on the same media as the ICV video files, and reference made to these files to associate them with the triggered AV file. Other data captured by the ALPR system 14 can also be embedded into the AV file as a data stream, or metadata, to further associate the ALPR functions with the recorded AV file.

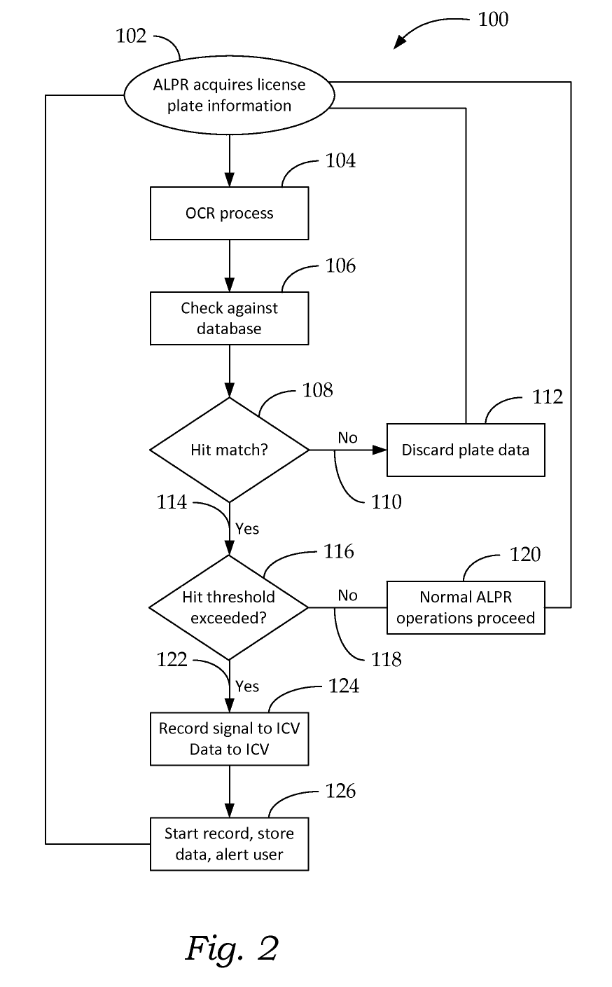

For example, referring to FIG. 2, a flow chart of the triggering function is generally indicated by reference numeral 100. When the ALPR system 14 acquires license plate information 102, the snapshot is processed to determine the text on the license plate 104. The license plate number is checked against a national, state, local, and/or stored database 106, and checked for a hit 108. If there is no hit 110, the plate date is discarded 112, and processing returns to the start 102. If a match is found 114, the hit is compared to a threshold 116. If the threshold is not exceeded 118, then the hit data may be stored in the ALPR system 14 or discarded 120, and processing returns to the start 102. If the hit exceeds the threshold 122, then a record signal is sent to the ICV system along with the hit data 124. The hit data may include the license plate OCR, the license plate JPEG, a JPEG image of the vehicle, and information relevant to the hit event. In response, the ICV system starts recording, stores the ALPR data, and provides an alert to the user via the display 52.

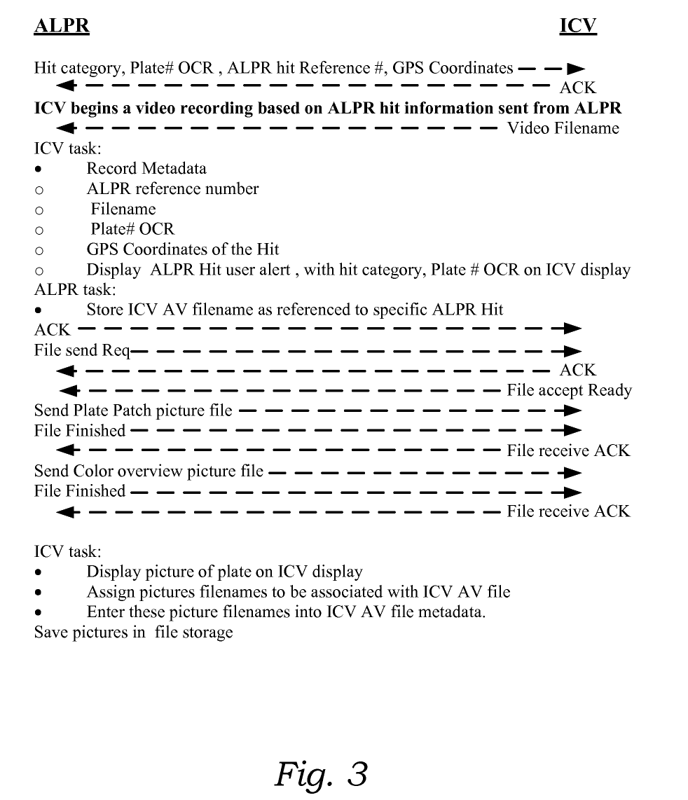

Referring to FIG. 3, a signal flow diagram is generally illustrated. When the ALPR system 14 determines that a license plate read is a hit, it sends a record signal with the hit category, plate number OCR, ALPR hit reference number, and GPS coordinates, for example, to the ICV system 12. The ICV system 12 responds with an acknowledge (ACK) signal, and begins recording. The ICV system 12 sends the video filename to the ALPR system 14 to associate with the license plate data. The ICV system 12 records metadata, ALPR reference number, file name, license plate number OCR, and GPS coordinates of the hit, for example, and displays an ALPR hit user alert on the display 52, along with the hit category, and plate number OCR, for example. The ALPR system 14 stores the AV filename as referenced to the specific ALPR hit, and sends the ICV system 12 and ACK signal. The ALPR system 14 may then send a file send request to the ICV system 12. The ICV system 12 sends an ACK signal to indicate that the ICV system 12 is ready to receive the license plate JPEG image. The ALPR system 14 sends the plate patch picture file and an end of file indicator to the ICV system 12. The ICV system 12 sends an ACK signal to the ALPR system 14. The ICV system 12 displays the picture of the license plate on the ICV display 52, assigns picture filename to be associated with the ICV AV file, enter the picture filename into the ICV AV file metadata, and saves the picture in the file storage 28.

The combined system of the present invention allows for a reduced current draw on the car battery, a single enclosure, a single power supply, and a much smaller footprint in the trunk of the vehicle. Integration advantages of the two video systems include combining ALPR hit and/or other information within the ICV video metadata. This allows for Back Office searches from either an ALPR or ICV video standpoint that can return a larger body of data for a specific ALPR it or ICV video recording, as the two types of evidence can now be associated with one another. Integration enables a larger “body of evidence” to indicate what took place in a particular event. Integration allows for synchronized time settings between the ICV and ALPR utilizing the ICV's internal GPS capabilities to set the system clock. A single secure login may be associated with both the ALPR application, and the ICV system to allow the user to sign in to both systems with a single login. Hit list “classification” allows the ALPR to initiate record on the ICV only at or above a defined infraction level. One or more of the ALPR cameras may be used as a direct input to the ICV's DVR to capture important activity occurring outside the field of view of the ICV cameras.

A simpler or perhaps even single main interface in the vehicle may be used for the officer (he/she does not need to “open” or watch the ALPR system as the ICV display will notify him/her of relevant events) during normal ICV and ALPR operation. This same interface may both show and control ALPR sub-system power and ready status, giving the officer more information and control from a single user interface.

The ALPR board may be autonomous in functionality in relation to the ICV system. The ALPR board may include connections for four or more ALPR cameras. Physically, the ALPR board may be mounted within the ICV system housing, or may include an interface connector to the ICV system 12. The ALPR board receives power and ground through the ICV system, and communicates with the ICV system through general purpose input/outputs (GPIO) and Ethernet connections.

The ALPR system 14 may have the capability for License Plate Recognition (LPR) supporting four or more VGA LPR units and/or XGA LPR units. Communication between the ALPR main board 42 and the ALPR camera units 40 may be via standard Ethernet, analog video, and FireWire.

OCR data may be routed through the ICV system to a mobile data computer (MDC) such as a laptop to allow the resident software to make comparisons to the resident hit list. Hit information by the software in the MDC may be communicated back to the ICV system via Ethernet, including:

License plate OCR

License plate JPEG

Vehicle Overview JPEG

Hit category

ALPR hit reference number

GPS coordinates

GPIOs to the ALPR board control/indicate the following:

Enable/disable ALPR

ALPR system is powered up

The ALPR camera units may include 2 cameras in each individual ALPR unit. Generally there may be one color overview camera for still context images and one infrared camera for ALPR images in each ALPR unit housing with IR or near-IR LEDS to illuminate target license plates for the IR camera.

It is to be understood that while certain now preferred forms of this invention have been illustrated and described, it is not limited thereto except insofar as such limitations are included in the following claims.

Having thus described the invention, what is claimed as new and desired to be secured by Letters Patent is as follows:

1. A video surveillance system comprising:
an in-car video (ICV) system having a video capture component coupled to one or more video cameras, a microprocessor coupled to said video capture component for receiving video data therefrom, and a memory for receiving video data from said microprocessor; and
an automatic license plate recognition (ALPR) coupled to said ICV system and having one or more ALPR cameras, a microprocessor coupled to said ALPR cameras for receiving ALPR data therefrom, and a memory for receiving license plate data from said microprocessor;
said ICV system responsive to receiving a trigger signal from said ALPR to record said video data.

2. The video surveillance system of claim 1 wherein said ICV system includes an Ethernet interface and said ALPR system includes an Ethernet interface coupled to said Ethernet interface of said ICV system.

3. The video surveillance system of claim 1 wherein said ALPR system receives power from said ICV system.

4. The video surveillance system of claim 1 wherein ICV system records said ALPR data received from said ALPR system.

5. The video surveillance system of claim 1 wherein said ICV system includes a general purpose input/output (GPIO) channel coupled to said ALPR system.

6. The video surveillance system of claim 5 wherein said ICV system receives said trigger signal from said ALPR system over said GPIO channel.

7. The video surveillance system of claim 1 wherein said video data includes metadata, and wherein said ALPR data includes metadata, and wherein said ICV system couples said metadata from said video data and said ALPR data, and records said coupled metadata.

8. A video surveillance system comprising:
an in-car video (ICV) system having an audio capture component coupled to one or more microphones, a video capture component coupled to one or more video cameras, a microprocessor coupled to said audio and video (AV) capture components for receiving AV data therefrom, a memory for receiving video data from said microprocessor, and a digital storage media; and
an automatic license plate recognition (ALPR) coupled to said ICV system and having one or more ALPR cameras, a microprocessor coupled to said ALPR cameras for receiving ALPR data therefrom, and a memory for receiving license plate data from said microprocessor;
said ICV system responsive to receiving a trigger signal from said ALPR to record said AV data on said digital storage media.

9. The video surveillance system of claim 8 wherein said AV data is first transferred from said memory of said ICV system to said digital storage media, then from said microprocessor.

10. The video surveillance system of claim 8 wherein ICV system includes an Ethernet interface and said ALPR system includes an Ethernet interface coupled to said Ethernet interface of said ICV system.

11. The video surveillance system of claim 8 wherein said ALPR system receives power from said ICV system.

12. The video surveillance system of claim 8 wherein said ICV system records said ALPR data received from said ALPR system on said digital storage device.

13. The video surveillance system of claim 8 wherein said ICV system includes a general purpose input/output (GPIO) channel coupled to said ALPR system.

14. The video surveillance system of claim 13 wherein said ICV system receives said trigger signal from said ALPR system over said GPIO channel.

15. The video surveillance system of claim 8 wherein said video data includes metadata, and wherein said ALPR data includes metadata, and wherein said ICV system couples said metadata from said video data and said ALPR data, and records said coupled metadata.

16. A video surveillance system comprising:
an in-car video (ICV) system having an audio capture component coupled to one or more microphones, a video capture component coupled to one or more video cameras, a microprocessor coupled to said audio and video (AV) capture components for receiving AV data therefrom, a memory for receiving video data from said microprocessor, a digital storage media, an Ethernet interface, and one or more general purpose input/output (GPIO) channels; and
an automatic license plate recognition (ALPR) coupled to said ICV system and having one or more ALPR cameras, a microprocessor coupled to said ALPR cameras for receiving ALPR data therefrom, a memory for receiving license plate data from said microprocessor, an Ethernet interface, and one or more GPIO channels;
said ICV system responsive to receiving a trigger signal from said ALPR to record said AV data on said digital storage media.

17. The video surveillance system of claim 16 wherein said AV data is first transferred from said memory of said ICV system to said digital storage media, then from said microprocessor.

18. The video surveillance system of claim 16 wherein said ALPR system receives power from said ICV system.

19. The video surveillance system of claim 16 wherein said ICV system receives said trigger signal from said ALPR system over said GPIO channel.

20. The video surveillance system of claim 8 wherein said video data includes metadata, and wherein said ALPR data includes metadata, and wherein said ICV system couples said metadata from said video data and said ALPR data, and records said coupled metadata on said digital storage media.
